(19) United States
(12) Patent Application Publication
(10) Pub. No.: US 2008/0119311 A1
(43) Pub. Date: May 22, 2008

(54) TENSIONING DEVICE FOR A TRACTION MECHANISM DRIVE

(75) Inventors: Manfred Wilhelm, Gerhardshofen (DE); Horst Adel, Rochester Hills, MI (US); Scott Ribey, Port Elgin (CA); Fred Seebeck, Royal Oak, MI (US); Scott Thompson, Warren, MI (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/943,709

(22) Filed: Nov. 21, 2007

Related U.S. Application Data
(60) Provisional application No. 60/866,698, filed on Nov. 21, 2006.

(51) Int. Cl. F16H 7/12

(52) U.S. Cl. 474/135

(57) ABSTRACT

Tensioning device (1) for a traction mechanism drive, such as a belt or a chain drive, with a tensioning arm (4), which can pivot about a pivot axle (3) relative to a body (2) and on whose distal end there is a roller (5) supported so that it can rotate for tensioning the traction mechanism, for the purpose of which there is a torsion spring (6) acting between the pivot axle (3) of the tensioning arm (4) and the body (2). The pivot axle (3) is supported in a sliding manner by at least one radial bearing arrangement (7) and at least one axial bearing arrangement (8) separated from this radial bearing arrangement, and the axial bearing (8) is constructed as a cone friction bearing and includes a cone bearing disk (9), which is locked in rotation with the pivot axle (3) and is guided subjected to friction on the end against a cone bearing surface (10) formed in the hub section of the tensioning arm (4).

### CROSS-REFERENCE TO RELATED APPLICATIONS

The present application claims the benefit of U.S. Provisional Application No. 60/866,698, filed Nov. 21, 2006, which is incorporated herein by reference as if fully set forth.

### FIELD OF THE INVENTION

The present invention relates to a tensioning device for a traction mechanism drive, such as a belt or chain drive, with a tensioning arm, which can pivot relative to a body and a pivot axle and on whose distal end a rotating roller is arranged for tensioning the traction mechanism, for which a torsion spring acting between the pivot axle of the tensioning arm and the body is provided, and the pivot axle is supported in a sliding way by at least one radial bearing arrangement and at least one axial bearing arrangement arranged separate from this radial bearing arrangement. In particular, the invention is focused on tensioning devices, in which the bearing arrangement is used ostensibly as a friction mechanism.

The field of use of tensioning devices according to the present invention extends especially to motor-vehicle technology. Internal combustion engines in motor vehicles are often equipped with traction mechanism drives, such as belt or chain drives, in order to use, for example, the rotational movement of the crankshaft for driving other assemblies, such as the coolant pump, the cooling fan, or especially the camshaft. In addition, a tensioning device according to the type of interest here can also be used outside of motor-vehicle technology, such as, for example, in machine and plant construction, where traction mechanism drives are used, which require mechanical belt tensioners for guaranteeing a sufficient contact friction between the traction mechanism and the associated driving or driven wheel. Tensioning devices of the type of interest here generate the necessary tension in the traction mechanism drive through a torsion spring, which pretensions the traction mechanism led around the rotating roller at the distal end of the tensioning arm.

From the laid-open, unexamined publication DE 10 2004 028 485 A1, a tensioning device for belts, chains, and the like is known, which is used, in particular, in internal combustion engines. This is constructed with a body that can be attached to a machine housing, with a tensioning arm, and with a torsion spring built on its hub part. At the free end of the tensioning arm there is a tensioning roll in active connection with the belt or the chain or the like, wherein the tensioning device further comprises a friction element, which is in active connection with the body and the tensioning arm, and which is constructed with a torsion-wound spiral or leg spring, whose ends or legs are connected to the base part and the tensioning arm for generating a torque between the tensioning arm and the body. A guide body is locked in rotation on the body, on which a hub section of the tensioning arm is guided under the intermediate connection of a combination sleeve. The hub part of the tensioning arm has a hub journal directed towards the body, wherein the spiral or leg spring is constructed as a multi-function spring, which acts as a pressure spring for its rotating function and which contacts the outer surface of the hub journal with at least one, preferably several windings. Thus, the bearing of the tensioning arm relative to the body or the pivot axle is constructed via a single combination sleeve. This does include a friction effect, so that oscillations, which are introduced into the tensioning arm via the traction mechanism, can be damped, but a lever moment is produced within the combination sleeve, which generates individual wear zones in the combination sleeve itself. Furthermore, the combination sleeve can be realized only with a relatively small radius, so that at least one part of the torsion spring can extend past the combination sleeve. Due to the small diameter of the combination sleeve, high surface pressures are generated, which considerably increase the wear of the combination sleeve in these regions.

### SUMMARY

Therefore, starting from the constructions of the state of the art, the object of the present invention is to create an axial bearing with a friction damping mechanism for a tensioning arm of a tensioning device, which generates the necessary friction between the tensioning arm and the body or the pivot axle and which has a simple structural construction.

This objective is met starting with a tensioning device according to the invention. The following description and claims provide further advantageous improvements of the invention.

The invention includes the technical teaching that the axial bearing is constructed as a cone-friction bearing and comprises a cone bearing disk, which is locked in rotation with the pivot axle and is guided subjected to friction at the end against a cone bearing surface formed in the hub section of the tensioning arm. Through the construction according to the invention for the axial bearing in the form of a cone-friction bearing, it is achieved that in the friction surface, an advantageous force distribution is produced, so that especially through the separate construction of a radial bearing arrangement with the axial bearing arrangement according to the invention, the cone bearing disk is loaded only in the axial direction. Thus, closed zones within the friction-loaded surface contact can be avoided, so that the cone bearing surface or the cone bearing disk is loaded uniformly with radial symmetry. Now if the torsion spring presses with an axial force component the cone bearing disk in the axial direction into the cone bearing surface in the hub section of the tensioning arm, then an increased normal force, which is composed of an axial force component and also a radial force component, is generated due to the angled arrangement of the contact surface relative to the pivot axle. For a given axial force, the normal force within the cone bearing disk in contact with the cone bearing surface increases, so that the achievable friction can be significantly increased for damping rotational oscillations of the tensioning arm via the pivot axle. The cone angle of the cone bearing disk is adapted to the cone angle of the cone bearing surface, so that the surfaces border each other in a plan-parallel arrangement.

As an advantageous embodiment of the axial bearing, it can be provided that between the cone bearing disk and the cone bearing surface, a friction ring is arranged in the hub section of the tensioning arm. The friction ring is arranged either locked in rotation on the cone bearing surface, so that this runs on the inside against the cone bearing disk subjected to friction. Alternatively, there is the possibility that the friction ring is locked in rotation with the cone bearing disk, and thus runs on the outside against the cone bearing surface subjected to friction. Here it must be determined that the effective friction radius for an outer side running against the cone bearing surface subjected to friction is greater than for an inner side running against the cone bearing disk subjected to friction.

According to another advantageous embodiment of the present invention, the friction ring comprises a catch peg on the cone bearing surface or on the cone bearing disk for a rotation-locked arrangement. According to the first embodiment, if the friction ring is locked in rotation with the cone bearing surface, then the catch peg is arranged on the outer side of the friction ring. According to the second embodiment, if the friction ring is locked in rotation with the cone bearing disk, then the catch peg is arranged on the inside of the friction ring in the direction of the cone bearing disk.

According to another advantageous embodiment, a catch groove, in which the catch peg engages for rotation-locked holding, is formed in the cone bearing disk or in the cone bearing surface. The catch peg on the friction ring can be formed as a type of latch or projection, which is connected either solidly to the friction ring or comprises a type of spring-elastic release in the friction ring, so that the catch peg can snap into the catch groove. It should also be noted that a plurality of catch pegs or catch grooves could be provided as a rotation-locking device between the cone bearing surface or the cone bearing disk and the friction ring.

Advantageously, the friction ring is made from a plastic material composed of a PTFE material, an organic plastic, a polyamide or a PTFE-bearing polyamide. However, there is also the possibility of producing the friction ring from a steel material or an aluminum material using a cutting method, die-casting technology, or forging technology, wherein each running surface can include cutting finishing work. The tensioning arm, the body, and also the cone bearing disk can be made from a steel material or an aluminum material, wherein, in particular, die-casting technology can be used advantageously for the geometric construction of the component.

According to another advantageous embodiment of the invention, it can be provided that the cone bearing disk, the cone bearing surface, and/or the friction ring can have a cone angle α, which includes a value of 10° to 60°, preferably 20° to 45°, and especially preferred 30°. Tests have shown that a cone angle of 30° allows optimum intensification of the axial contact force due to the torsion spring for forming a normal force. Thus, an optimum damping of oscillations introduced into the tensioning arm is possible, without causing premature wear of the friction partners due to contact pressure forces that are too high.

According to the invention, the cone bearing disk is locked in rotation and in the axial direction with the pivot axle, wherein the pivot axle comprises a passage borehole, in order to fix the tensioning device to an internal combustion engine with a connection means extending through the passage borehole. According to a first embodiment, the cone bearing disk can have a friction contact surface, which is formed by the end outer surface of the conical wheel. This is used so that it can rotate under the given cone angle within the cone bearing surface in the hub section of the tensioning arm. The cone bearing surface is formed as a type of truncated cone-shaped borehole in the hub section of the tensioning arm. Furthermore, according to a second embodiment there is the possibility to form the cone bearing disk itself with a cone bearing surface constructed on the inside, wherein this encloses a truncated cone formed with radial symmetry on the hub section of the tensioning arm. Thus, the same axial bearing arrangement is created, wherein only the cone formation has been performed inverted in the axial direction.

### BRIEF DESCRIPTION OF THE DRAWINGS

Additional measures improving the invention are shown in more detail below together with the description of preferred embodiments of the invention with reference to the figures.

Shown are:

FIG. 1 a cross-sectional side view of a tensioning device with an axial bearing arrangement according to the present invention;

FIG. 2 a perspective view of a pivot axle and also a cone bearing disk attached to this axis;

FIG. 3 a view of a friction ring with a catch peg according to the present invention; and

FIG. 4 a schematic representation of another embodiment of a tensioning device according to the present invention.

### DETAILED DESCRIPTION OF THE PREFERRED EMBODIMENTS

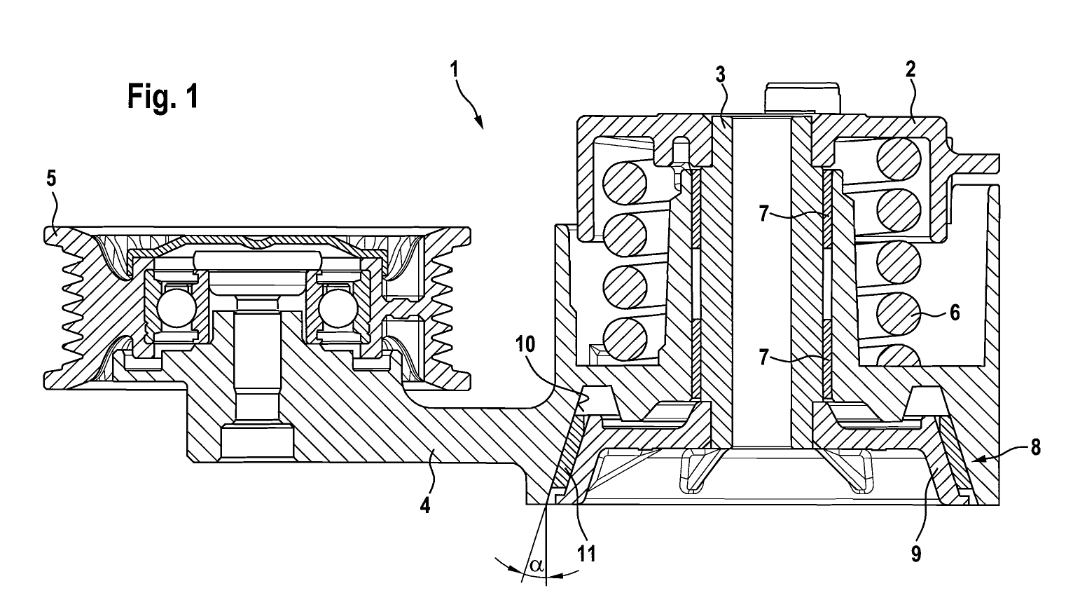

The tensioning device 1 shown in FIG. 1 comprises first a body 2, which is locked in rotation and in the axial direction with a pivot axle 3. A cone bearing disk 9 is arranged, in turn, locked in rotation and in the axial direction, on the pivot axle 3, wherein the pivot axle 3 has a passage borehole, in order to attach the tensioning device 1, for example, to the internal combustion engine of a motor vehicle.

A tensioning arm 4 is supported so that it can rotate on the pivot axle 3, wherein the bearing is formed by a radial bearing arrangement 7 and also an axial bearing arrangement 8. The radial bearing arrangement 7 is composed of two annular radial bearing sections extending along the longitudinal axis of the pivot axle 3. The axial bearing arrangement 8 comprises a cone bearing disk 9, which is inserted into a conical borehole formed by a cone bearing surface 10. Between the cone bearing disk 9 and the cone bearing surface 10 there is a friction ring 11, wherein the cone bearing disk 9 is pulled by an axial force into the cone bearing surface 10. The axial force is caused by an axial force component of a torsion spring 6, wherein the torsion spring 6 exerts a compressive force only on the hub section of the tensioning arm 4. The torsion spring 6 further presses on the body 2 and thus on the pivot axle 3, so that a traction force component, which is transferred to the cone bearing disk 9, is introduced into the pivot axle 3. Thus, the cone bearing disk 9 is pulled into the cone bearing surface 10 within the hub section of the tensioning arm 4. The tensioning arm 4 comprises a roller 5, which is supported so that it can rotate and around which the traction mechanism to be tensioned, such as a belt or a chain, is tensioned. The tension is applied by the torsion force component of the torsion spring 6, so that a traction force is constantly applied to the traction mechanism via the roller 5 and the tensioning arm 4.

The cone angle between the cone bearing disk 9 or the cone bearing surface 10 and the rotational axis of the tensioning arm 4 about the pivot axle 3 is given by the cone angle α corresponds approximately to 30°. Through this angle, the axial force component is amplified by the torsion spring 6 into a normal force component, which acts in the cone bearing surface 10 on the cone bearing disk 9. The normal force is considerably greater than the axial force, which is generated by the torsion spring, so that a considerably increased surface pressure is produced on the friction side of the friction ring 11. In comparison with planar friction disks, reinforced vibration damping can be achieved, because the friction force can also assume correspondingly larger values due to the increased normal force.

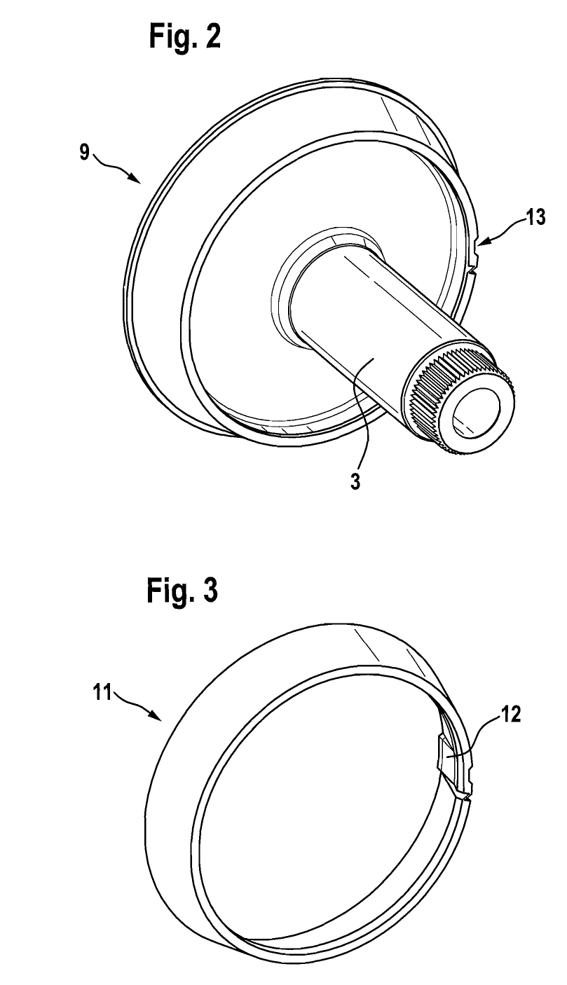

FIG. 2 shows a perspective view of a cone bearing disk 9, which is locked in the axial direction and in rotation with a pivot axle 3. The outer side conical contact surface for the friction ring is clear to see, wherein according to the present embodiment of the cone bearing disk 9 in FIG. 2, a catch groove 13 is formed within the outer surface of the cone bearing disk 9, so that in this way the friction ring is locked in rotation with the cone bearing disk 9.

FIG. 3 shows the friction ring 11, which is constructed with a catch peg 12. The catch peg 12 of the friction ring 11 in FIG. 3 can engage in the catch groove 13 in the cone bearing disk 9 according to the representation in FIG. 2. Thus, the friction and the dissipation of the friction work takes place through the oscillating movement of the tensioning arm between the friction ring 11 and the cone bearing surface in the hub section of the tensioning arm.

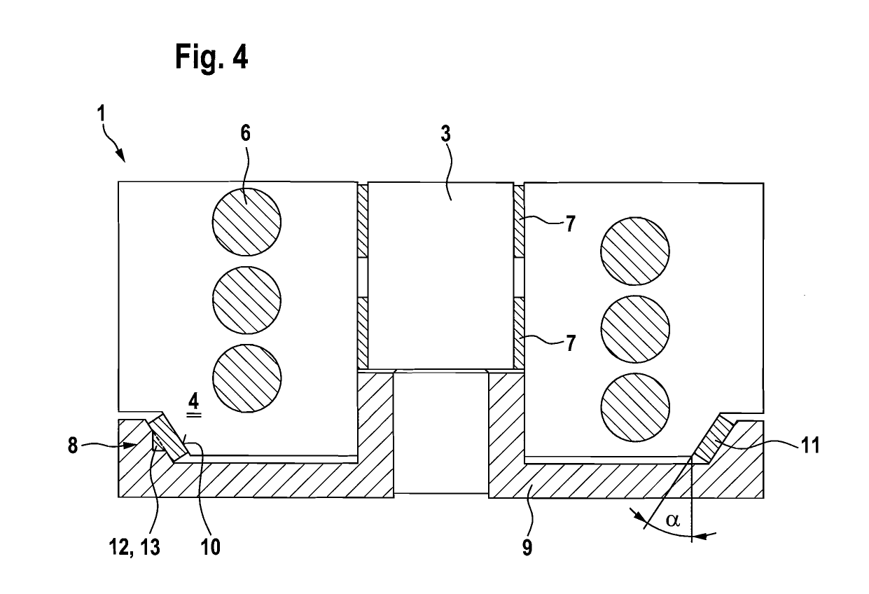

FIG. 4 shows schematically another embodiment of a tensioning device 1, which comprises, in turn, a pivot axle 3, which is locked in the axial direction and in rotation with a cone bearing disk 9. A torsion spring 6 applies an axial force onto the cone bearing disk 9, so that the cone bearing disk 9 is pretensioned for forming an axial bearing arrangement 8 in the axial direction against the hub section of the tensioning arm 4. However, according to this embodiment, the cone bearing surface 10 is formed as a truncated cone-shaped outer radial surface, wherein the conical surface of the cone bearing disk 9 is formed as a truncated cone-shaped inner radial surface. Schematically, the catch peg 12 and also the catch groove 13 are shown between the friction ring 11 and also the cone bearing disk 9, so that the friction ring 11 does not rotate with the rotational movement of the hub section of the tensioning arm 4, but instead is arranged locked in rotation with the cone bearing disk 9. In this embodiment, the cone construction is again specified with the cone angle α, which can be assumed to have a value of 30°.

The invention is not limited in its construction to the preferred embodiment specified above. Instead, a number of variants are conceivable, which use the shown solution also for fundamentally differently shaped constructions. Thus, it is conceivable, for example, for a double construction of axial bearings according to the invention to be formed as cone friction bearings within the tensioning device in an opposing arrangement, so that a radial bearing arrangement 7 about the pivot axle 3 can be eliminated. Thus, two axial bearing arrangements 8 are arranged opposite each other either in an X-arrangement or in an O-arrangement, whereby additional reinforcement of an achievable damping is allowed by increased friction.

### LIST OF REFERENCE NUMBERS

1 Tensioning device
2 Body
3 Pivot axle
4 Tensioning arm
5 Roller
6 Torsion spring
7 Radial bearing arrangement
8 Axial bearing arrangement
9 Cone bearing disk
10 Cone bearing surface
11 Friction ring
12 Catch peg
13 Catch groove α Cone angle

1. Tensioning device (1) for a traction mechanism drive, comprising a tensioning arm (4), which can pivot about a pivot axle (3) relative to a body (2) and having a roller (5) on a distal end thereof supported so that it can rotate for tensioning the traction mechanism, a torsion spring (6) acting between the pivot axle (3) of the tensioning arm (4) and the body (2), the pivot axle (3) is supported in a sliding manner by at least one radial bearing arrangement (7) and at least one axial bearing arrangement (8) separated from the radial bearing arrangement, the axial bearing (8) comprises a cone friction bearing and includes a cone bearing disk (9), which is locked in rotation with the pivot axle (3) and is guided subject to friction on one end against a cone bearing surface (10) formed in a hub section of the tensioning arm (4).

2. Tensioning device (1) according to claim 1, wherein a friction ring (11) is arranged between the cone bearing disk (9) and the cone bearing surface (10) in the hub section of the tensioning arm (4).

3. Tensioning device (1) according to claim 2, wherein the friction ring (11) is locked in rotation with the cone bearing surface (10) and the friction ring (11) runs with an inside against the cone bearing disk (9) subjected to friction.

4. Tensioning device (1) according to claim 3, wherein the friction ring (11) comprises a catch peg (12) for a rotation-locked arrangement on the cone bearing surface (10).

5. Tensioning device (1) according to claim 4, wherein at least one catch groove (13), in which the catch peg (12) engages for rotation-locked holding, is formed in the cone bearing disk (9).

6. Tensioning device (1) according to claim 2, wherein the friction ring (11) is locked in rotation with the cone bearing disk (9) and the friction ring (11) runs with an outside against the cone bearing surface (10) subjected to friction.

7. Tensioning device (1) according to claim 6, wherein the friction ring (11) comprises a catch peg (12) for a rotation-locked arrangement on the cone bearing disk (9).

8. Tensioning device (1) according to claim 7, wherein at least one catch groove (13), in which the catch peg (12) engages for rotation-locked holding, is formed in the cone bearing surface (10).

9. Tensioning device (1) according to claim 2, wherein the friction ring (11) is made from a plastic material comprising a PTFE material, a PTFE-bearing polyamide, an organic plastic, or a polyamide.

10. Tensioning device (1) according to claim 2, wherein the friction ring (11) has a friction coating composed of a PTFE coating, on at least a side of a running surface.

11. Tensioning device (1) according to claim 2, wherein at least one of the cone bearing disk (9), the cone bearing surface (10), or the friction ring (11) has a cone angle (α), which includes a value of 10° to 60°.

12. Tensioning device (1) according to claim 2, wherein the cone bearing disk (9) is locked in the axial direction and in rotation with the pivot axle (3), the pivot axle (3) comprises a passage borehole, in order to fix the tensioning device (1) to an internal combustion engine with a connecter extending through the passage borehole.
